(19) United States
(12) Patent Application Publication
(10) Pub. No.: US 2024/0022496 A1
(43) Pub. Date: Jan. 18, 2024

(54) NETWORK OPTIMIZATION BY PREDICTING AND PROACTIVELY MANAGING HOT-PREFIXES

(71) Applicant: Cisco Technology, Inc., San Jose, CA (US)

(72) Inventors: Pamela Krishnamachary, Pleasanton, CA (US); Swati Garg, Cupertino, CA (US); Anzhela Hillebrand, San Jose, CA (US); Charles Lee, Berkeley, CA (US); David C. White, JR., St. Petersburg, FL (US)

(21) Appl. No.: 17/863,710

(22) Filed: Jul. 13, 2022

(51) Int. Cl. H04L 45/02; H04L 43/0876

(52) U.S. Cl. CPC H04L 45/02; H04L 43/0876

(57) ABSTRACT

A method includes obtaining, from a plurality of first devices in a first time zone, data associated with hot-prefixes requested at one or more first devices of the plurality of first devices during a first time interval. The hot-prefixes are associated with network addresses that are frequently requested during the first time interval. The method further includes predicting, based on the data associated with the hot-prefixes, prefixes that will become hot-prefixes during a second time interval in a second time zone to determine predicted hot-prefixes, and transmitting an indication of the predicted hot-prefixes to a plurality of second devices configured to provide networking services in the second time zone prior to a start of the second time interval in the second time zone.

### TECHNICAL FIELD

The present disclosure relates to network optimization.

### BACKGROUND

In large routing network deployments, critical traffic that carries prefix data associated with destination network addresses is collected dynamically on a local node or a local network over a period of time. If a catastrophic event occurs during the dynamic collection phase and if the prefixes have not been stored in protected system resources, serious outages may occur in a network.

### BRIEF DESCRIPTION OF THE DRAWINGS

FIG. 1 is a diagram of a system configured to predict and preload hot-prefix data, according to an example embodiment.

FIG. 2 is a flow diagram illustrating finetuning network configuration based on predicting hot-prefixes, according to an example embodiment.

FIG. 3 illustrates a diagram of a system configured to preload predicted hot-prefixes into local network devices, according to an example embodiment.

FIG. 4 is a flow diagram illustrating a method of predicting and preloading hot-prefix data, according to an example embodiment.

FIG. 5 is a hardware block diagram of a device that may be configured to perform the operations involved in predicting hot-prefixes for a time interval, according to an example embodiment.

### DESCRIPTION OF EXAMPLE EMBODIMENTS

### Overview

In one embodiment, a method is provided for obtaining, from a plurality of first devices in a first time zone, data associated with hot-prefixes requested at one or more first devices of the plurality of first devices during a first time interval, the hot-prefixes being associated with network addresses that are frequently requested during the first time interval; predicting, based on the data associated with the hot-prefixes, prefixes that will become hot-prefixes during a second time interval in a second time zone to determine predicted hot-prefixes; and transmitting an indication of the predicted hot-prefixes to a plurality of second devices configured to provide networking services in the second time zone prior to a start of the second time interval in the second time zone.

### Example Embodiments

A typical web scaler or service provider network stores similar routing tables across regional and international zones for route prefixes, including Internet Protocol version 4 (IPv4) and IPv6 route prefixes. A route prefix is a portion of a destination network address. The number of route prefixes requested for a service provider network may be large, but a very small percentage of the requested route prefixes carry a majority of live traffic. For example, for IPv4, a distribution of route prefixes in a large deployment can be one million routes or more. For IPv6, the number of route prefixes may be a few hundred to half a million routes. However, only a small percentage of the route prefixes may carry a majority of the traffic. For example, in a routing tabling with 500,000 prefixes, 90% of the overall traffic may traverse only 300 prefixes.

The prefixes that carry a large amount (e.g., highest amount) of traffic may be referred to as “hot-prefixes”. In some embodiments, a prefix may be a hot-prefix if it carries more than a threshold amount or percentage of a maximum amount of traffic. In other embodiments, prefixes may be hot-prefixes if the prefixes carry above a threshold percentage of traffic in a routing table. In the above example, the 300 prefixes associated with 90% of the traffic may be considered hot-prefixes. In other embodiments, a prefix may be a hot-prefix if the prefix is at maximum usage for a period of time (e.g., ten minutes). The prefixes that are hot-prefixes for a local network may vary throughout the day (e.g., based on consumer behavior at different times of the day, based on network addresses requested during different times of the day, based on events that occur in the news, etc.).

The prefixes that carry the highest amount of traffic are critical and any glitches may lead to catastrophic traffic blackholing events and outages. Hot-prefixes are detected to be hot dynamically over a period of time (e.g., after ten minutes of monitoring maximum usage, the local algorithms may identify a prefix as hot). After the prefix is marked hot, the prefix is downloaded to a protected, high bandwidth system resource, such as a hardware cache. If a catastrophic event (e.g., a network churn created by a line card reload) occurs during the ten minutes of monitoring maximum usage, traffic blackholing may occur.

In some situations, hot-prefix information may be used to optimize network performance by predicting prefixes that may become hot-prefixes. The predicted hot-prefixes may be preloaded into routers across networks in different time zones globally. Preloading the predicted hot-prefixes in a protected system resource may protect the predicted hot-prefixes in the event of a catastrophic network event.

Embodiments described herein provide for predicting prefixes that will become hot-prefixes during a time slot or time interval in time zones based on hot-prefix information associated with the time slot in a different time zone. In some embodiments, a super controller may obtain information from local software-defined network (SDN) controllers in a time zone indicating the prefixes that are hot-prefixes during a time slot or time interval. Based on the received information, the super controller may predict the prefixes that may become hot-prefixes during the time slot or time interval in different time zones. The super controller may transmit information associated with the predicted hot-prefixes to SDN controllers in different time zones ahead of the time slot. The SDN controllers may preload the predicted hot-prefixes into local routers ahead of a start of the time slot.

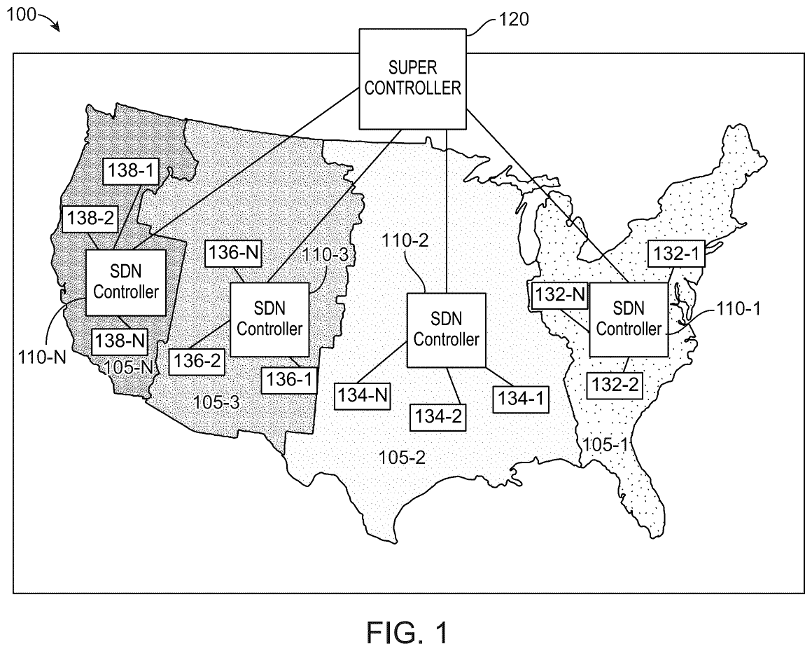

Reference is first made to FIG. 1. FIG. 1 shows a block diagram of a networking system 100 that is configured to predict prefixes that will become hot-prefixes, according to embodiments described herein. The networking system 100 includes SDN controllers 110-1 to 110-N, super controller 120, and network devices 132-1, 132-2, . . . 132-N; 134-1, 134-2, . . . 134-N; 136-1, 136-2, . . . 136-N; and 138-1, 138-2, . . . 138-N.

As illustrated in FIG. 1, SDN controller 110-1 and network devices 132-1 to 132-N are located in time zone 105-1, SDN controller 110-2 and network devices 134-1 to 134-N are located in time zone 105-2, SDN controller 110-3 and network devices 136-1 to 136-N are located in time zone 105-3, and SDN controller 110-N and network devices 138-1 to 138-N are located in time zone 105-N. In some situations, the actual physical locations of the SDN controllers and network devices may not be the same as the geographical region for which they are allocated to provide networking services. In other words, an SDN controller and one or more local network devices could be located outside of the geographical time zone that they are configured to serve. In some embodiments, an SDN controller that is time zone-aware may manage network devices in any time zone or more than one time zone. For example, a time zone-aware SDN controller may observe the hot-prefixes forming in the Eastern time zone and pre-load those prefixes into network devices the SDN controller controls in the Central time zone.

Although one SDN controller is illustrated in each time zone for simplicity, any number of SDN controllers may be located in each time zone. In addition, although four time zones across the United States are illustrated in FIG. 1, embodiments described herein may be applied globally across any number of time zones and/or countries. In the example illustrated in FIG. 1, time zone 105-2 is one hour behind time zone 105-1, time zone 105-3 is two hours behind time zone 105-1, and time zone 105-N is three hours behind time zone 105-1.

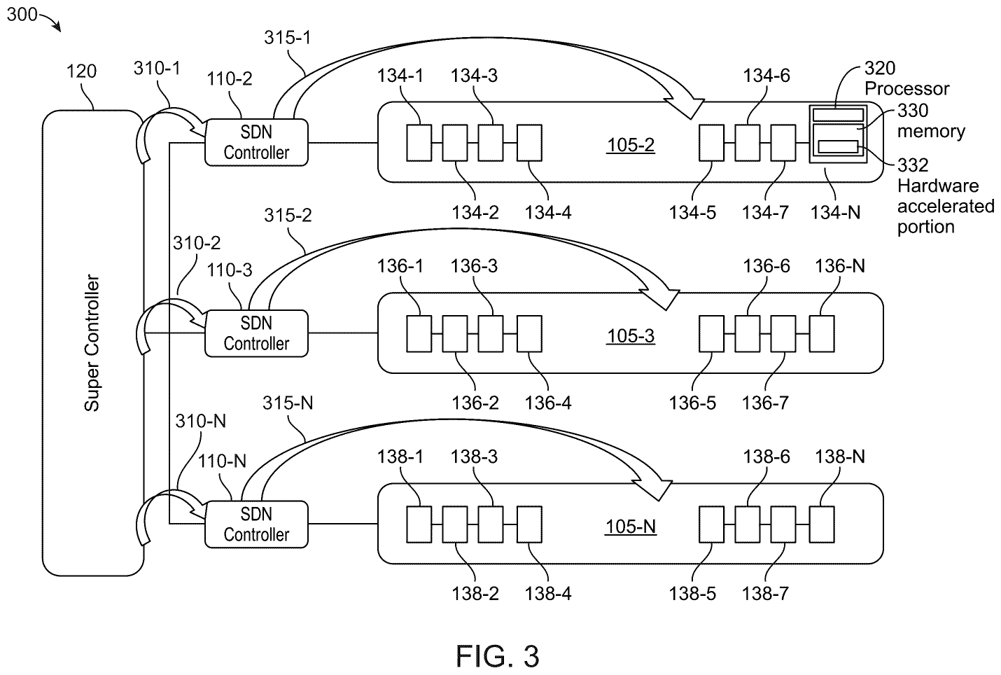

In the example described with respect to FIG. 1, SDN controllers 110-1 to 110-N may receive indications of prefixes that are hot-prefixes in particular time slots or time intervals from network devices in their respective time zones. For example, SDN controller 110-1 may receive indications of hot-prefixes from network devices 132-1 to 132-N. Network devices 132-1 to 132-N may be devices (e.g., routers) that route traffic from a source to a destination. Network devices 132-1 to 132-N may store routing tables for routing traffic to destinations. In some embodiments, and as described further with respect to FIG. 3, hot-prefixes may be stored in a different location in a memory of network devices 132-1 to 132-N than prefixes that are not hot-prefixes. In other embodiments, hot-prefixes may be stored in different types of hardware or memory that have different costs and performance characteristics.

According to some embodiments described herein, network devices 132-1 to 132-N may identify prefixes that are hot-prefixes for particular time periods, time intervals, or time slots. For example, the network devices 132-1 to 132-N may identify prefixes that are hot-prefixes for a time slot that lasts an hour, several hours, or a different duration (e.g., a time slot may be from 8:00 to 9:00 in the morning or from 8:00 to 10:00 in the evening in a particular time zone). Hot-prefixes may be detected when the prefix is hot dynamically over a period of time. For example, a prefix may be identified as hot by comparing the number of times the prefix is used with respect to other prefixes over a time interval. The “hottest” prefix is the prefix that is used the most frequently (e.g., the prefix that has the most route lookups to its destination, which equates to the most sessions/packets to that destination). In some embodiments, a hot-prefix may no longer be hot if the prefix is no longer one of the most used prefixes for a period of time. In addition, hot prefixes may be defined by the amount of traffic a prefix carries within a time interval. For example, out of 500,000 routes, only 300 routes may be carrying 90% of the overall traffic for an extended time period. There may be a cap on the number of hot prefixes a device can store. The cap may be a hardware limit that is based on the constraint of the hardware.

The prefixes that are hot-prefixes may vary at different times of the day (e.g., based on consumer behavior). For example, during school hours, video sharing services may be used during class and prefixes associated with video sharing services may be carrying maximum traffic. Therefore, during school hours, the prefixes associated with video sharing services may be hot-prefixes. However, in the evening time, streaming services may be accessed at home more than video sharing services. Therefore, during evening hours, prefixes associated with streaming services may be hot-prefixes and the prefixes associated with video sharing services may no longer be hot-prefixes.

In some embodiments, prefixes may become hot-prefixes based on events that are taking place. For example, if a major event or breaking news event has occurred, consumers may visit news sites or services and the prefixes associated with the news sites or services may become hot-prefixes. The prefixes associated with the news sites or services may become hot-prefixes at different times in different locations. For example, users in time zone 105-1 may wake up and access news sites or services and the prefixes associated with the news sites or services may become hot-prefixes in time zone 105-1. One hour later, users in time zone 105-2 may wake up and access news sites or services. Therefore, the prefixes associated with the news sites or services may become hot-prefixes in time zone 105-2 approximately one hour after becoming hot-prefixes in time zone 105-1.

After identifying the hot-prefixes, network devices 132-1 to 132-N may store the hot-prefixes in protected resources, like a hardware cache with a high bandwidth memory. Storing the hot-prefixes in the protected resources may protect the hot-prefixes from line card reloads, network flaps, and churns. In addition, the protected resources may be hardware accelerated portions of the network devices. Therefore, traffic destined for a destination associated with a hot-prefix may be routed faster and with more bandwidth than traffic destined for destinations associated with prefixes that are not hot-prefixes.

Network devices 132-1 to 132-N transmit to SDN controller 110-1 indications of the hot-prefixes for each time slot or time interval. SDN controller 110-1 collects and stores the hot-prefix information received from network devices 132-1 to 132-N. In addition, SDN controllers 110-2 to 110-N collect and store hot-prefix information from network devices 134-1 to 134-N, 136-1 to 136-N, and 138-1 to 138-N, respectively, in a manner similar to the manner described above.

SDN controllers 110-1 to 110-N may share their hot-prefix data with super controller 120. For example, each SDN controller 110-1 to 110-N may transmit to super controller 120 the hot-prefix data for each time slot in each time zone. Each SDN controller 110-1 to 110-N may continuously update super controller 120 so that the SDN controllers 110-1 and 110-N are synchronized with super controller 120. Super controller 120 may collate the hot-prefix data received from SDN controllers 110-1 to 110-N. Super controller 120 may perform hot-prefix prediction for each time slot and time zone based on the collated hot-prefix data. In some embodiments, the hot-prefix prediction may be performed by other devices/controllers that manage devices across distances and time zones.

In some embodiments, super controller 120 may predict which prefixes will become hot-prefixes in a time slot in a time zone based on the hot-prefixes in a corresponding time slot in another time zone. For example, if a particular prefix is a hot-prefix in a time slot that spans from 6:00 to 9:00 in the morning in time zone 105-1, super controller 120 may predict that the same prefix will be a hot-prefix in the time slots that span from 6:00 to 9:00 in the morning in time zones 105-2, 105-3, and 105-N. In some embodiments, super controller 120 may analyze data patterns for hot-prefixes over a longer time span (e.g., weeks, months, seasons, years, etc.) and super controller 120 may predict hot-prefixes based on analyzing the data patterns. For example, super controller 120 may predict that prefixes associated with sports services may be hot-prefixes at particular time slots during particular seasons (e.g., the times intervals that span a time during or after football games during football season, etc.).

In some embodiments, super controller 120 may predict that prefixes will become hot-prefixes based on special events (e.g., sporting events, concerts, etc.). For example, super controller 120 may predict which prefixes will become hot-prefixes based on the prefixes that were hot-prefixes during similar special events. In some embodiments, super controller 120 may predict which prefixes will become hot-prefixes based on breaking news events or major events based on prefixes that were previously hot-prefixes during similar breaking news events or major events. Super controller 120 may additionally predict that some prefixes will become hot-prefixes in some time zones, but not in other time zones. In some embodiments, super controller 120 may perform the hot-prefix prediction based on additional data analysis.

Super controller 120 may transmit indications of the predicted hot-prefixes to SDN controllers 110-1 to 110-N. For example, super controller 120 may predict hot-prefixes for different time slots in each time zone and transmit information associated with the hot-prefixes to each SDN controller 110-1 to 110-N. In some embodiments, super controller 120 may transmit different hot-prefix information to each SDN controller 110-1 to 110-N based on the predicted hot-prefixes in the time zone associated with the SDN controller.

SDN controllers 110-1 to 110-N may preload the hot-prefixes proactively ahead of a time slot in which the prefixes are predicted to become hot-prefixes for the time zone. For example, super controller 120 may transmit an indication to SDN controller 110-2 that a particular prefix will become a hot-prefix during a particular time slot in time zone 105-2 and SDN controller 110-2 may preload the hot-prefixes in network devices 134-1 to 134-N prior to a start of the time slot. In some embodiments, SDN controller 110-2 may preload the hot-prefixes by sending an indication of the hot-prefixes and the time slot to network devices 134-1 to 134-N.

Network devices 134-1 to 134-N may proactively store the hot-prefixes in hardware accelerated/protected resources (e.g., a hardware cache) before a start of a time interval when the hot-prefixes are predicted to be hot. The preloading protects the hot-prefixes from network flaps/churns. For example, instead of monitoring the prefixes to determine that the prefixes are hot for a period of time (e.g., ten minutes) before storing the hot-prefixes in the protected resource, the hot-prefixes are preloaded in protected resources. Therefore, the hot-prefixes are protected from catastrophic network events during the time span in which the network devices might ordinarily be monitoring the prefixes before storing the prefixes in the protected resources. In addition, traffic destined for services associated with the hot-prefixes may be routed more quickly and with greater bandwidth resources than traffic destined for network addresses associated with prefixes that are not hot. Network devices 134-1 to 134-N may store the prefixes that are not hot in a less expensive/low bandwidth memory, which saves on power, thermal requirements, and cost.

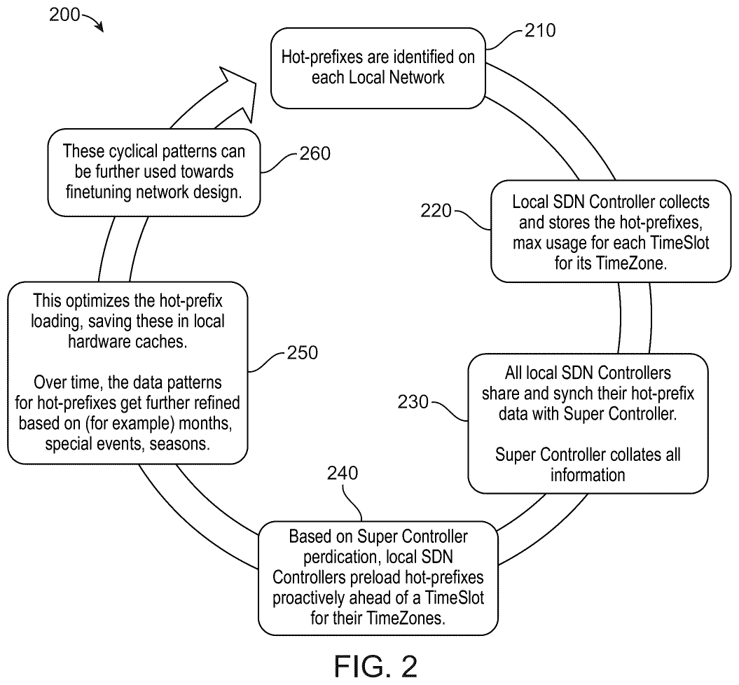

Reference is now made to FIG. 2 with continued reference to FIG. 1. FIG. 2 is a diagram illustrating a method 200 of predicting hot-prefixes, according to embodiments described herein.

At 210, hot-prefixes are identified at each local network. For example, network devices 132-1 to 132-N, 134-1 to 134-N, 136-1 to 136-N, and 138-1 to 138-N may identify hot-prefixes (e.g., based on identifying prefixes that are at a maximum usage or above a threshold usage for a period of time). The network devices may identify different hot-prefixes at different time slots. At 220, local SDN controllers collect and store the hot-prefixes that are at maximum usage for each time slot in a time zone. For example, SDN controllers 110-1 to 110-N obtain hot-prefix information from the network devices in their time zone and store the hot-prefix information. In some embodiments, the hot-prefix data identifies the time slots and time zones in which the prefixes are hot-prefixes.

At 230, the local SDN controllers share and synchronize their hot-prefix data with super controller 120. For example, SDN controllers 110-1 to 110-N continuously transmit the hot-prefix information to super controller 120 so that the hot-prefix information stored at SDN controllers 110-1 to 110-N is synchronized with the super controller 120. The hot-prefix information or data may include information associated with the time slots and time zones in which the prefixes are hot-prefixes. Super controller 120 receives hot-prefix data from each SDN controller 110-1 to 110-N and collates or combines the hot-prefix information. Super controller 120 predicts which prefixes will become hot-prefixes in different time slots in different time zones based on the collated hot-prefix information.

At 240, based on the hot-prefix predictions of super controller 120, local SDN controllers preload hot-prefixes ahead of a time slot in their time zones. For example, super controller 120 may transmit predicted hot-prefix information to each SDN controller 110-1 to 110-N. The predicted hot-prefix information may be specific to each different SDN controller 110-1 to 110-N. The predicted hot-prefix information may include information about the prefixes that are predicted to become hot-prefixes in different time slots in the time zones corresponding to the SDN controllers 110-1 to 110-N. Each SDN controller 110-1 to 110-N may preload the hot-prefixes into local network devices ahead of the time slot in which the prefixes are predicted to be hot-prefixes. For example, SDN controller 110-1 to 110-N may transmit information associated with the predicted hot-prefixes to network devices 132-1 to 132-N and network devices 132-1 to 132-N may store the hot-prefixes in a protected/hardware accelerated portion of the network device 132-1 to 132-N, such as in hardware caches.

As illustrated at 250, by preloading the hot-prefixes in the local hardware caches, the hot-prefix loading is optimized. For example, instead of network devices 132-1 to 132-N identifying the hot-prefixes by determining that the prefixes are at maximum usage (or above a threshold usage) for a period of time (e.g., ten minutes) before loading the hot-prefixes in the hardware caches, the hot-prefixes are preloaded in the hardware caches. By preloading the hot-prefixes, the hot-prefixes are protected from any catastrophic events during the time period in which the network devices 132-1 to 132-N monitor the maximum usage of the prefixes. In this way, the hot-prefixes are protected in the hardware cache before the prefixes become hot-prefixes. In addition, the hot-prefixes may be stored in a hardware accelerated portion of the network devices 132-1 to 132-N. Therefore, traffic associated with the hot-prefixes may be routed more quickly and with a higher bandwidth than traffic associated with prefixes that are not hot.

Over time, the data patterns for hot-prefixes are further refined based on, for example, months, special events, seasons, etc. In other words, super controller 120 may become better at predicting which prefixes will become hot-prefixes at a granular level at different times of the year or based on previous hot-prefix data associated with past months, seasons, special events, breaking news events, etc. In some embodiments, super controller 120 may analyze data associated with traffic and hot-prefixes during months in previous years or when special events or breaking news events occurred in the past. Based on the data analysis, super controller 120 may more accurately predict, on a granular level, which prefixes will become hot-prefixes during particular time slots in subsequent months or when similar special events or breaking news events occur. For example, each year at 7:00 am on February 2nd in the Eastern time zone, there is a hot-prefix to a specific destination caused by people watching to see if the groundhog Punxsutawney Phil will see its shadow. Therefore, based on the analysis of the hot-prefixes in previous years, the prefix may be pre-staged across devices as it is known that the prefix will become hot at a particular time every year.

As shown at 260, the cyclical patterns can be further used toward finetuning network configuration. For example, by accurately predicting hot-prefixes in particular time slots, a configuration of a network may be adjusted or changed to accommodate traffic associated with the hot-prefixes. In this way, content may be retrieved more quickly and customer experience may be improved.

Reference is now made to FIG. 3 with continued reference to FIGS. 1 and 2. FIG. 3 is a diagram illustrating a networking system 300 in which hot-prefixes are preloaded into local network devices, according to embodiments described herein. Networking system 300 includes super controller 120, SDN controllers 110-2 to 110-N, and network devices 134-1 to 134-N(in time zone 105-2), 136-1 to 136-N(in time zone 105-2), and 138-1 to 138-N(in time zone 105-N).

In the example illustrated in FIG. 3, super controller 120 has received hot-prefix information from SDN controllers 110-1 to 110-N and has predicted the prefixes that will become hot-prefixes in different time slots and time zones. At 310-1 to 310-N, super controller 120 transmits the predicted hot-prefixes for different time slots to SDN controllers 110-2 to 110-N. In the example described with respect to FIG. 3, the predicted hot-prefixes are based, at least in part, on the predicted hot-prefixes in different time slots in time zone 105-1. For example, if particular prefixes are hot-prefixes in a first time slot in time zone 105-1, super controller 120 may predict that the same prefixes will be hot-prefixes in corresponding time slots in time zones 105-2 to 105-N. Super controller 120 may predict that prefixes will become hot-prefixes based on additional and/or different factors.

The hot-prefixes transmitted at 310-1 to 310-N may be different for each SDN controller 110-2 to 110-N and for each time zone 105-2 to 105-N. Furthermore, because SDN controllers 110-2 to 110-N are in different time zones, super controller 120 may transmit hot-prefix information for a particular time slot to each of the SDN controllers 110-2 to 110-N at different times. Super controller 120 may continuously update SDN controllers 110-2 to 110-N with predicted hot-prefixes before the start of each time slot and/or super controller 120 may transmit hot-prefix information for multiple time slots at the same time to SDN controllers 110-2 to 110-N.

At 315-1 to 315-N, SDN controllers 110-2 to 110-N may preload the predicted hot-prefixes for time slots into local network devices prior to the start of the time slots. For example, SDN controller 110-2 may transmit the predicted hot-prefixes for a first time slot to network devices 134-1 to 134-N prior to a start of the first time slot. In a similar manner, SDN controller 110-3 may transmit the predicted hot-prefixes for the first time slot to network devices 136-1 to 136-N prior to the start of the first time slot and SDN controller 110-N may transmit the predicted hot-prefixes for the first time slot to network devices 138-1 to 138-N prior to the start of the first time slot. In some embodiments, due to time differences in time zones 105-2 to 105-N, at 315-1 to 315-N, SDN controllers 110-2 to 110-N may transmit hot-prefix data to the local network devices for different time slots.

After receiving the predicted hot-prefix information, the local network devices may store the hot-prefix information in a hardware accelerated/protected portion of the network device prior to the start of the time slot associated with the predicted hot-prefixes. FIG. 3 illustrates a more detailed view of network device 134-N, as an example. As illustrated, network device 134-N includes at processor 320 and a memory 330 that includes a hardware accelerated portion 332. Although not illustrated for simplicity, network devices 134-1 to 134-N, 136-1 to 136-N, and 138-1 to 138-N may additionally include a processor 320, a memory 330 with a hardware accelerated portion 332. When network device 134-N receives the hot-prefix information for a time slot, network device 134-N may store the hot-prefixes in the accelerated portion of memory 330 prior to the start of the time slot associated with the hot-prefixes. Prefixes that are not hot-prefixes may be stored in a less expensive/low bandwidth portion of memory 330, which saves on power, thermal requirements, and cost.

When routing information (such as the hot-prefix information) is stored in the hardware accelerated portion 332, traffic associated with the routing information is routed in an accelerated manner and with a greater bandwidth allotment. Therefore, traffic destinated for network addresses associated with the hot-prefixes may be routed more quickly than traffic destined for network addresses associated with prefixes that are not hot-prefixes. By preloading the hot-prefixes prior to the start of a time slot, the traffic destined for the destinations associated with the hot-prefixes may be routed more quickly from the beginning of the time slot (instead monitoring the prefixes for a period of time to determine whether they are hot-prefixes). In this way, pre-loading the hot-prefixes may lead to a higher level of customer satisfaction. In addition, the hardware accelerated portion 332 may be a protected resource. Therefore, by storing the hot-prefixes in the hardware accelerated portion 332, the hot-prefixes are protected from network churns and flaps.

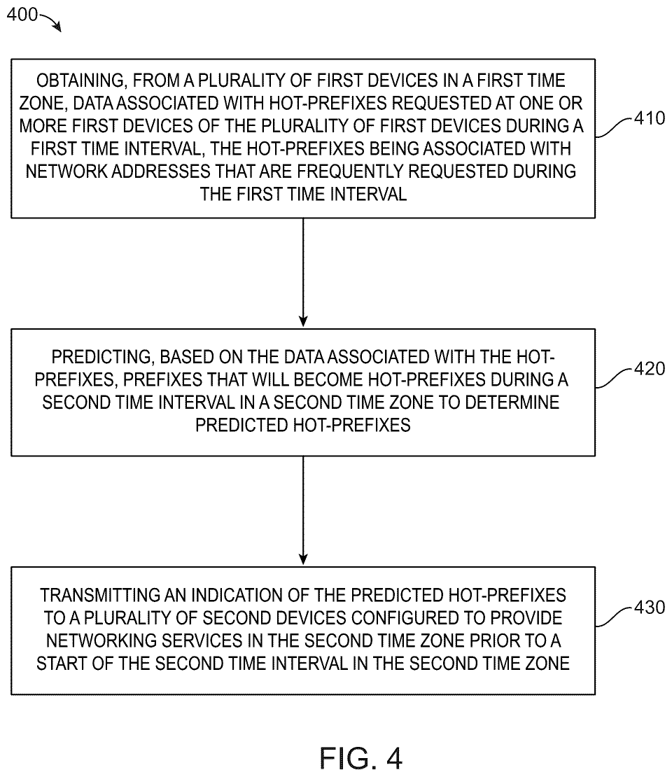

Reference is now made to FIG. 4 with continued reference to FIGS. 1-3. FIG. 4 is a flow diagram illustrating a method 400 of preloading predicted hot-prefixes for a time slot or time interval into network devices prior to the start of the time slot or time interval, according to embodiments described herein. Method 400 may be performed by super controller 120 in combination with SDN controllers 110-1 to 110-N and network devices 132-1 to 132-N, 134-1 to 134-N, 136-1 to 136-N, and 138-1 to 138-N.

Method 400 begins at 410 by obtaining, from a plurality of first devices in a first time zone, data associated with hot-prefixes requested at one or more first devices of the plurality of first devices during a first time interval. The hot-prefixes are associated with network addresses that are frequently requested during the first time interval. For example, super controller 120 may obtain information associated with prefixes that are hot-prefixes during a first time interval from SDN controllers 110-1 to 110-N. As described above, SDN controllers 110-1 to 110-N may receive the hot-prefix information from network devices 132-1 to 132-N, 134-1 to 134-N, 136-1 to 136-N, and 138-1 to 138-N, respectively, based on traffic destined to network addresses during particular time intervals. Prefixes associated with network addresses that are requested frequently during the time interval may be hot-prefixes.

At 420, predicted hot-prefixes may be determined by predicting, based on the data associated with the hot-prefixes, prefixes that will become hot-prefixes during a second time interval in a second time zone. For example, super controller 120 may collate hot-prefix information or data associated with the first time interval obtained from SDN controllers 110-1 to 110-N and may use the collated hot-prefix information to predict which prefixes will become hot-prefixes in a second time interval in a second time zone. In some embodiments, super controller 120 may predict that prefixes that are hot-prefixes in a first time interval in a first time zone will be hot-prefixes in a corresponding second time interval in a second time zone. Super controller 120 may additionally determine the predicted hot-prefixes based on analyzing the data received from the SDN controllers 110-1 to 110-N over a period of time. For example, super controller 120 may additionally predict the hot-prefixes based on super-prefix information from previous months, seasons, special events, breaking news events, etc.

At 430, an indication of the predicted hot-prefixes is transmitted to a plurality of second devices configured to provide networking services in a second time zone prior to a start of the second time interval in the second time zone. For example, super controller 120 may transmit indications of the hot-prefixes to SDN controllers 110-1 to 110-N for preloading the hot-prefixes in network devices 132-1 to 132-N, 134-1 to 134-N, 136-1 to 136-N, and 138-1 to 138-N prior to the start of the second time period. In some embodiments, the second time slot in the second time zone may correspond to the first time slot in the first time zone. For example, the first time interval may be from 8:00 to 9:00 in the morning in time zone 105-1 and the second time interval may be from 8:00 to 9:00 in the morning in time zone 105-2. Network devices 132-1 to 132-N, 134-1 to 134-N, 136-1 to 136-N, and 138-1 to 138-N may each store the hot-prefixes in a protected resource, such as hardware accelerated portion 332 of memory 330. Traffic destined to network addresses associated with the hot-prefixes stored in the hardware accelerated portion 332 may be routed more quickly than traffic destined to network addresses that are associated with prefixes that are not hot-prefixes and not stored in the hardware accelerated portion 332.

By storing the hot-prefixes in protected resources, hot-prefixes may be protected from network catastrophic events (e.g., a line card reload that ends up in a much lower bandwidth system) during a period of time in which the network devices may ordinarily be monitoring prefixes to identify hot-prefixes. In addition, since traffic destined to network addresses associated with hot-prefixes stored in the hardware accelerate portion is routed more quickly, preloading the hot-prefixes before the time interval in which the prefixes become hot-prefixes may lead to a longer period of time in which the traffic is router more quickly and a higher level of customer satisfaction. Preloading the hot-prefixes ahead of the targeted time slot or time interval helps prevent outages, protects critical data, and keeps the overall cost, power, and thermal requirements of products low.

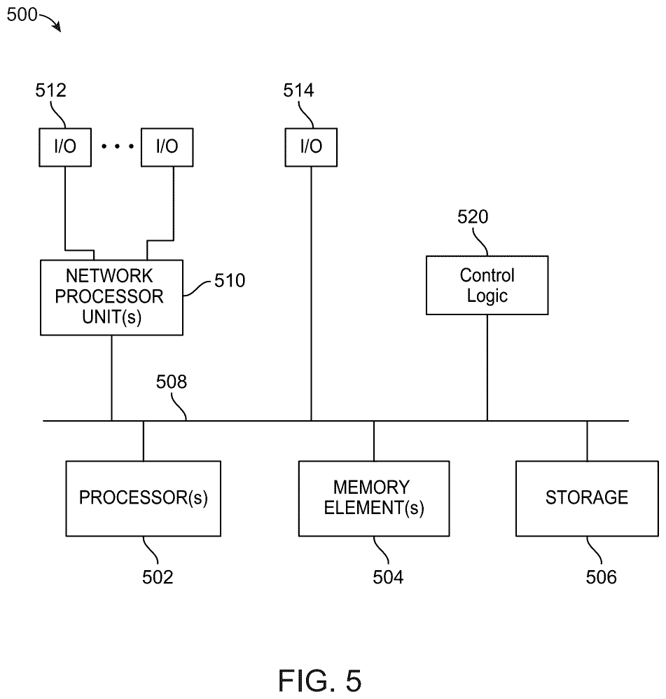

Referring to FIG. 5, FIG. 5 illustrates a hardware block diagram of a computing device 500 that may perform functions of a device associated with operations discussed herein in connection with the techniques depicted in FIGS. 1-4. In various embodiments, a computing device, such as computing device 500 or any combination of computing devices 500, may be configured as any devices as discussed for the techniques depicted in connection with FIGS. 1-4 in order to perform operations of the various techniques discussed herein.

In at least one embodiment, the computing device 500 may include one or more processor(s) 502, one or more memory element(s) 504, storage 506, a bus 508, one or more network processor unit(s) 510 interconnected with one or more network input/output (I/O) interface(s) 512, one or more I/O interface(s) 514, and control logic 520. In various embodiments, instructions associated with logic for computing device 500 can overlap in any manner and are not limited to the specific allocation of instructions and/or operations described herein.

In at least one embodiment, processor(s) 502 is/are at least one hardware processor configured to execute various tasks, operations and/or functions for computing device 500 as described herein according to software and/or instructions configured for computing device 500. Processor(s) 502 (e.g., a hardware processor) can execute any type of instructions associated with data to achieve the operations detailed herein. In one example, processor(s) 502 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 504 and/or storage 506 is/are configured to store data, information, software, and/or instructions associated with computing device 500, and/or logic configured for memory element(s) 504 and/or storage 506. For example, any logic described herein (e.g., control logic 520) can, in various embodiments, be stored for computing device 500 using any combination of memory element(s) 504 and/or storage 506. Note that in some embodiments, storage 506 can be consolidated with memory element(s) 504 (or vice versa), or can overlap/exist in any other suitable manner.

In at least one embodiment, bus 508 can be configured as an interface that enables one or more elements of computing device 500 to communicate in order to exchange information and/or data. Bus 508 can be implemented with any architecture designed for passing control, data and/or information between processors, memory elements/storage, peripheral devices, and/or any other hardware and/or software components that may be configured for computing device 500. In at least one embodiment, bus 508 may be implemented as a fast kernel-hosted interconnect, potentially using shared memory between processes (e.g., logic), which can enable efficient communication paths between the processes.

In various embodiments, network processor unit(s) 510 may enable communication between computing device 500 and other systems, entities, etc., via network I/O interface(s) 512 (wired and/or wireless) to facilitate operations discussed for various embodiments described herein. Examples of wireless communication capabilities include short-range wireless communication (e.g., Bluetooth), wide area wireless communication (e.g., 4G, 5G, etc.). In various embodiments, network processor unit(s) 510 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 500 and other systems, entities, etc. to facilitate operations for various embodiments described herein. In various embodiments, network I/O interface(s) 512 can be configured as one or more Ethernet port(s), Fibre Channel ports, any other I/O port(s), and/or antenna(s)/antenna array(s) now known or hereafter developed. Thus, the network processor unit(s) 510 and/or network I/O interface(s) 512 may include suitable interfaces for receiving, transmitting, and/or otherwise communicating data and/or information in a network environment.

I/O interface(s) 514 allow for input and output of data and/or information with other entities that may be connected to computing device 500. For example, I/O interface(s) 514 may provide a connection to external devices such as a keyboard, keypad, a touch screen, and/or any other suitable input and/or output device now known or hereafter developed. This may be the case, in particular, when the computing device 500 serves as a user device described herein. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, particularly when the computing device 500 serves as a user device as described herein.

In various embodiments, control logic 520 can include instructions that, when executed, cause processor(s) 502 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 520) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), static random access memory (SRAM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 504 and/or storage 506 can store data, software, code, instructions (e.g., processor instructions), logic, parameters, combinations thereof, and/or the like used for operations described herein. This includes memory element(s) 504 and/or storage 506 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

In one form, a computer-implemented method is provided that includes obtaining, from a plurality of first devices in a first time zone, data associated with hot-prefixes requested at one or more first devices of the plurality of first devices during a first time interval, the hot-prefixes being associated with network addresses that are frequently requested during the first time interval; predicting, based on the data associated with the hot-prefixes, prefixes that will become hot-prefixes during a second time interval in a second time zone to determine predicted hot-prefixes; and transmitting an indication of the predicted hot-prefixes to a plurality of second devices configured to provide networking services in the second time zone prior to a start of the second time interval in the second time zone.

In one example, the plurality of second devices preload the predicted hot-prefixes into a plurality of routers prior to the start of the second time interval. In another example, the hot-prefixes are preloaded into hardware accelerated portions of the plurality of routers. In another example, the hot-prefixes are identified by the plurality of first devices as hot-prefixes that are at maximum usage during the first time interval in the first time zone. In another example, the method further includes analyzing data patterns associated with network communications with the hot-prefixes, wherein predicting the prefixes that will become hot-prefixes further includes predicting the prefixes that will become hot-prefixes based on analyzing the data patterns.

In another example, the method includes adjusting configurations of a network associated with a second device of the plurality of second devices based on analyzing the data patterns. In another example, the plurality of first devices or the plurality of second devices are software-defined network controllers. In another example, the second time interval in the second time zone corresponds to the first time interval in the first time zone.

In another form, an apparatus including: a memory; a network interface configured to enable network communication; and a processor, wherein the processor is configured to perform operations including: obtaining, from a plurality of first devices in a first time zone, data associated with hot-prefixes requested at one or more first devices of the plurality of first devices during a first time interval, the hot-prefixes being associated with network addresses that are frequently requested during the first time interval; predicting, based on the data associated with the hot-prefixes, prefixes that will become hot-prefixes during a second time interval in a second time zone to determine predicted hot-prefixes; and transmitting an indication of the predicted hot-prefixes to a plurality of second devices configured to provide networking services in the second time zone prior to a start of the second time interval in the second time zone.

In yet another form, one or more non-transitory computer readable storage media encoded with instructions are provided that, when executed by a processor, cause the processor to execute a method including: obtaining, from a plurality of first devices in a first time zone, data associated with hot-prefixes requested at one or more first devices of the plurality of first devices during a first time interval, the hot-prefixes being associated with network addresses that are frequently requested during the first time interval; predicting, based on the data associated with the hot-prefixes, prefixes that will become hot-prefixes during a second time interval in a second time zone to determine predicted hot-prefixes; and transmitting an indication of the predicted hot-prefixes to a plurality of second devices configured to provide networking services in the second time zone prior to a start of the second time interval in the second time zone.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 502.11 (e.g., Wi-Fi®/Wi-Fi6®), IEEE 502.16 (e.g., Worldwide Interoperability for Microwave Access (WiMAX)), Radio-Frequency Identification (RFID), Near Field Communication (NFC), Bluetooth™ mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of° can be represented using the’(s)′ nomenclature (e.g., one or more element(s)).

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

What is claimed is:

1. A computer-implemented method comprising:
obtaining, from a plurality of first devices in a first time zone, data associated with hot-prefixes requested at one or more first devices of the plurality of first devices during a first time interval, the hot-prefixes being associated with network addresses that are frequently requested during the first time interval;
predicting, based on the data associated with the hot-prefixes, prefixes that will become hot-prefixes during a second time interval in a second time zone to determine predicted hot-prefixes; and
transmitting an indication of the predicted hot-prefixes to a plurality of second devices configured to provide networking services in the second time zone prior to a start of the second time interval in the second time zone.

2. The computer-implemented method of claim 1, wherein the plurality of second devices preload the predicted hot-prefixes into a plurality of routers prior to the start of the second time interval.

3. The computer-implemented method of claim 2, wherein the hot-prefixes are preloaded into hardware accelerated portions of the plurality of routers.

4. The computer-implemented method of claim 1, wherein the hot-prefixes are identified by the plurality of first devices as hot-prefixes that are at maximum usage during the first time interval in the first time zone.

5. The computer-implemented method of claim 1, further comprising:
analyzing data patterns associated with network communications with the hot-prefixes,
wherein predicting the prefixes that will become hot-prefixes further comprises predicting the prefixes that will become hot-prefixes based on analyzing the data patterns.

6. The computer-implemented method of claim 5, further comprising:
adjusting configurations of a network associated with a second device of the plurality of second devices based on analyzing the data patterns.

7. The computer-implemented method of claim 1, wherein the plurality of first devices or the plurality of second devices are software-defined network controllers.

8. The computer-implemented method of claim 1, wherein the second time interval in the second time zone corresponds to the first time interval in the first time zone.

9. An apparatus comprising:
a memory;
a network interface configured to enable network communication; and
a processor, wherein the processor is configured to perform operations comprising:
obtaining, from a plurality of first devices in a first time zone, data associated with hot-prefixes requested at one or more first devices of the plurality of first devices during a first time interval, the hot-prefixes being associated with network addresses that are frequently requested during the first time interval;
predicting, based on the data associated with the hot-prefixes, prefixes that will become hot-prefixes during a second time interval in a second time zone to determine predicted hot-prefixes; and
transmitting an indication of the predicted hot-prefixes to a plurality of second devices configured to provide networking services in the second time zone prior to a start of the second time interval in the second time zone.

10. The apparatus of claim 9, wherein the plurality of second devices preload the predicted hot-prefixes into a plurality of routers prior to the start of the second time interval.

11. The apparatus of claim 10, wherein the hot-prefixes are preloaded into hardware accelerated portions of the plurality of routers.

12. The apparatus of claim 9, wherein the hot-prefixes are identified by the plurality of first devices as hot-prefixes that are at maximum usage during the first time interval in the first time zone.

13. The apparatus of claim 9, wherein the processor is further configured to perform operations comprising:
analyzing data patterns associated with network communications with the hot-prefixes,
wherein predicting the prefixes that will become hot-prefixes further comprises predicting the prefixes that will become hot-prefixes based on analyzing the data patterns.

14. The apparatus of claim 13, wherein the processor is further configured to perform operations comprising:
adjusting configurations of a network associated with a second device of the plurality of second devices based on analyzing the data patterns.

15. The apparatus of claim 9, wherein the plurality of first devices or the plurality of second devices are software-defined network controllers.

16. The apparatus of claim 9, wherein the second time interval in the second time zone corresponds to the first time interval in the first time zone.

17. One or more non-transitory computer readable storage media encoded with instructions that, when executed by a processor, cause the processor to execute a method comprising:
obtaining, from a plurality of first devices in a first time zone, data associated with hot-prefixes requested at one or more first devices of the plurality of first devices during a first time interval, the hot-prefixes being associated with network addresses that are frequently requested during the first time interval;
predicting, based on the data associated with the hot-prefixes, prefixes that will become hot-prefixes during a second time interval in a second time zone to determine predicted hot-prefixes; and
transmitting an indication of the predicted hot-prefixes to a plurality of second devices configured to provide networking services in the second time zone prior to a start of the second time interval in the second time zone.

18. The one or more non-transitory computer readable storage media of claim 17, wherein the plurality of second devices preload the predicted hot-prefixes into a plurality of routers prior to the start of the second time interval.

19. The one or more non-transitory computer readable storage media of claim 18, wherein the hot-prefixes are preloaded into hardware accelerated portions of the plurality of routers.

20. The one or more non-transitory computer readable storage media of claim 17, wherein the hot-prefixes are identified by the plurality of first devices as hot-prefixes that are at maximum usage during the first time interval in the first time zone.
